(19) United States
(12) Patent Application Publication
(10) Pub. No.: US 2006/0195404 A1
(43) Pub. Date: Aug. 31, 2006

(54) System and method for providing grace licensing to disconnected network license users

(76) Inventors: Laszlo Elteto, Irvine, CA (US); Jam Khan, Long Beach, CA (US); Derick Snyder, Buena Park, CA (US); Tu Le, Irvine, CA (US); Pratyush Kumar, New Delhi (IN)

Correspondence Address: VENABLE LLP, P.O. BOX 34385, WASHINGTON, DC, 20045-9998, US

(21) Appl. No.: 11/319,552

(22) Filed: Dec. 29, 2005

Related U.S. Application Data
(60) Provisional application No. 60/640,186, filed on Dec. 29, 2004.

(51) Int. Cl. G06Q 99/00

(52) U.S. Cl. 705/59

(57) ABSTRACT

A method and/or system for providing grace licensing to disconnected network license users provides a server with a grace enabled license having a grace criteria, provides a client computer with an application operable with the grace enabled license, provides the grace enabled license from the server to the client computer when the client computer is communicatively connected to the server, and operates the application on the client computer according to the grace criteria when the client computer is disconnected from the server. The grace criteria can include a parameter(s) including a number of times the application is operable on a client computer when the client computer is disconnected from the server, a total number of hours the application is operable on a client computer when the client computer is disconnected, and/or a maximum number of days the application is operable on a client computer when the client computer is disconnected.

### CROSS-REFERENCE TO RELATED APPLICATION

This application claims the benefit of U.S. Provisional Patent Application Ser. No. 60/640,186, filed Dec. 29, 2004, which is incorporated herein by reference.

### BACKGROUND OF THE INVENTION

1. Field of the Invention

The present invention relates generally to licensing and, more particularly, to a method and/or system for providing grace licensing to disconnected network license users.

2. Description of the Related Art

Software licensing has a long history. Software developers and companies helping them try various ways to help license software against unauthorized use. Companies often use electronic license management for distributing applications in a secure way. Leading companies like SafeNet Inc., provide a suite of applications, commonly referred to as licensing systems, to help developers in using electronic license management for their applications.

One of the typical problems that customers face in using a networked licensed application is the inability to use the application under pressing times due to the absence of a corporate network. For example, say a user uses an application on their laptop computer on Friday, Dec. 1, 2004 during office hours after obtaining a license from the network license server. The user then launches the application again at home on Saturday, Dec. 11, 2004. The licensed application could then not be authorized from the license server running in the user's office (corporate network). The application then fails to run.

Other similar urgent situations could include a requirement for a field executive to compile a project with some last minute changes using a licensed application before making a presentation. This may require access to the licensed application for some time not exceeding a few minutes or hours. However, he may not be able to run the application.

Under these and other similar circumstances, common licensing options prove to be more of a hindrance rather than a solution. They present unhappy user experiences. Licensing solutions exist that provide commuter or mobile licensing options that require certain minimum preparation, such as checking out a license, before actually making use of the protected application when disconnected from the network.

Therefore, a need exists for a method and system for providing grace licensing to disconnected network license users. The present invention provides the convenience of using a licensed application despite an inability to access the enterprise network at home.

### SUMMARY OF THE INVENTION

Embodiments of the present invention provide a method and/or system for providing grace licensing to disconnected network license users. The method and/or system method and/or system provides a server with a grace enabled license having a grace criteria, provides a client computer with an application operable with the grace enabled license, provides the grace enabled license from the server to the client computer when the client computer is communicatively connected to the server, and operates the application on the client computer according to the grace criteria when the client computer is disconnected from the server. The grace criteria can include at least one parameter including, for example, a number of times the application is operable on a client computer when the client computer is disconnected from the server, a total number of hours the application is operable on a client computer when the client computer is disconnected from the server, and/or a maximum number of days the application is operable on a client computer when the client computer is disconnected from the server.

### BRIEF DESCRIPTION OF THE DRAWINGS

FIG. 1 is a block diagram of a system for providing grace licensing to disconnected network license users according to an embodiment of the present invention.

FIG. 2 is a method embodiment for providing grace licensing to disconnected network license users according to the present invention.

FIG. 3 is a method embodiment for running a grace enabled application from a client computer when the client computer is disconnected from a license server according to the present invention.

### DETAILED DESCRIPTION OF THE PREFERRED EMBODIMENTS

Embodiments of the present invention relate to a method and system for providing grace licensing to disconnected license users. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

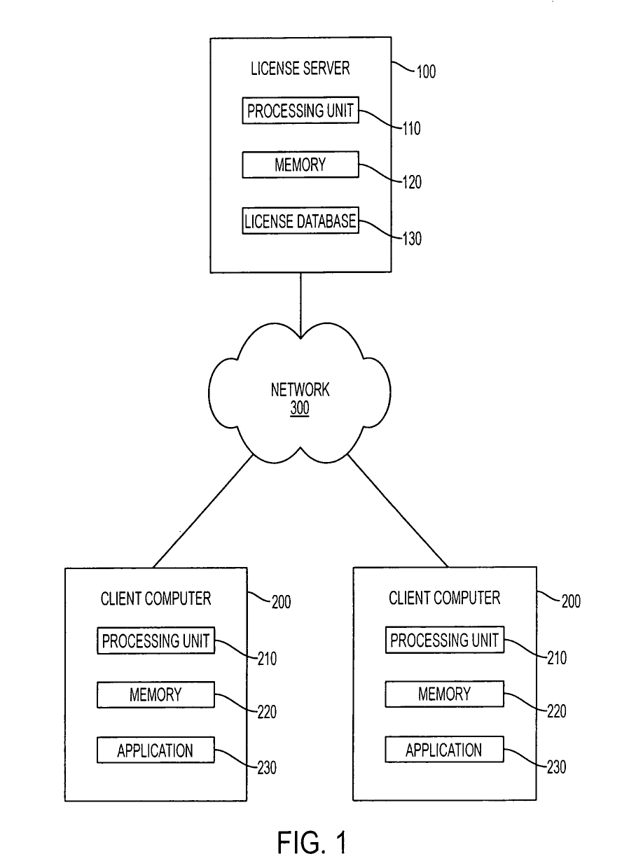

Referring to the drawings, FIG. 1 shows a system including one or more license servers 100 and one or more client computers 200. The license server 100 and the client computer 200 may be communicatively coupled or interconnected over a data communication network 300 that may be a local area network, a wide area network, the Internet, etc. The license server 100 and the client computer 200 may each be implemented on any number of desired kinds of computers, including a workstation, a desktop computer, a laptop computer, a notebook computer, a handheld computer, etc. The license server 100 may include a processing unit 110, a system memory 120, a license database 130, a system bus that interconnects various system components, including the system memory 120 to the processing unit 110, and any other desired computer component for facilitating input, output, display, communications, performance, quality, etc. The client computer 200 may include a processing unit 210, a system memory 220, an application 230, a system bus that interconnects various system components, including the system memory 220 to the processing unit 210, and any other desired computer component for facilitating input, output, display, communications, performance, quality, etc. While the FIG. 1 shows one license server 100 and two client computers 200, any number of license servers 100 and client computers 200 may be used. Similarly, any number of applications 230 may be stored on a client computer 200.

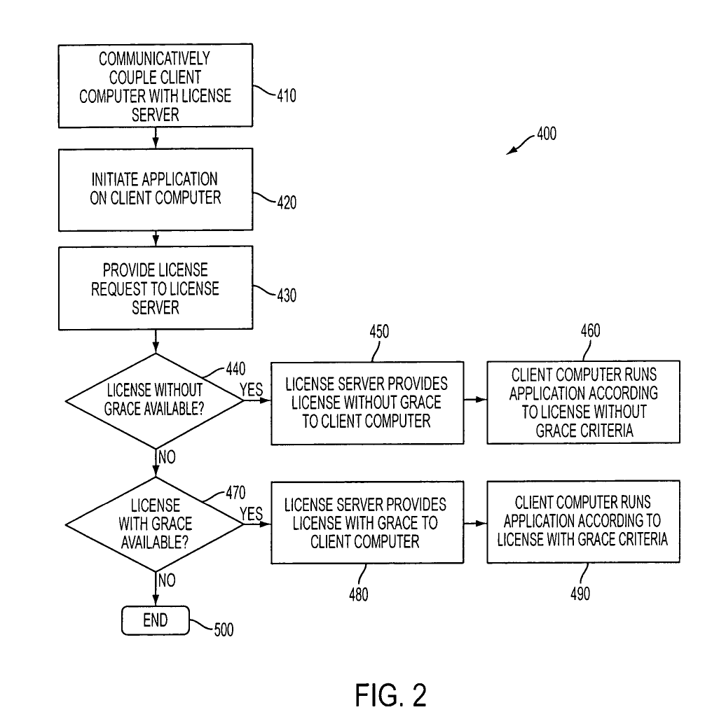

FIG. 2 illustrates a method embodiment 400 for providing grace licensing to disconnected users using a system such as the system shown in FIG. 1. In step 410, a client computer 200 becomes communicatively coupled or interconnected to a license server 100 over a network 300. The client computer 200 begins running a particular application 230 in step 420, and the application 230 requests a license from the license server 100, if one is necessary, in step 430. One or more licenses may be stored in the license database 130, any of which may be grace enabled (license with grace) or non-grace enabled (license without grace).

A grace enabled license allows an application 230 to be run on a client computer 200 if the client computer 200 becomes disconnected with the license server 100. A non-grace enabled license allows an application to be run on a client computer 200 when the client computer 200 is connected to the license server 100. The license server 100 determines whether a non-grace enabled license is available for the particular application 230 from the license database 130 in step 440. The license server 100 provides the client computer 200 with a non-grace enabled license if one is available in step 450. The client computer 200 can then run the application 230 according to criteria associated with the non-grace enabled license criteria.

Once the client computer 200 becomes intentionally or non-intentionally disconnected from the license server 100, the client computer 200 can no longer run the application 230 and the application 230 ceases to run. The license server 100 determines whether a grace-enabled license is available for the particular application 230 from a license database 130 in step 470. The license server 100 provides the client computer 200 with a grace enabled license if one is available in step 480. The client computer 200 can then run the application 230 according to criteria associated with the license with grace in step 490. A message is provided to the client computer 200 in step 500 if no license is available from the license database 130 and the client computer 200 cannot run the application 230.

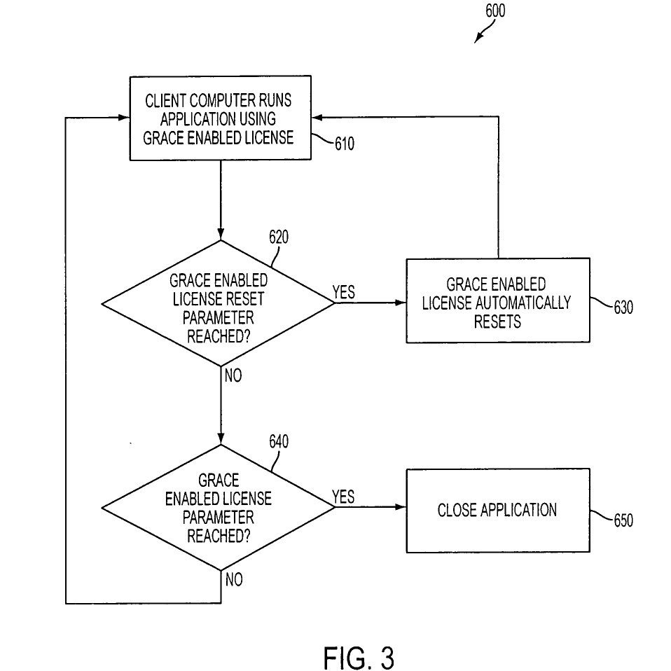

FIG. 3 illustrates a method embodiment 600 for a client computer running 200 a grace enabled application 230 when the client computer 200 is disconnected from the license server 100. Before the client computer 200 can run a grace enabled application 230, the client computer 200 needs to have previously received a grace enabled license in some manner. The client computer 200 begins running a particular application 230 in step 610. The application 230 determines whether a grace enabled license reset parameter has been reached in step 620. If a grace enabled license reset parameter has been reached the grace license can be automatically reset in step 630. Alternatively, if a grace enabled license parameter has been reached the grace license can be reset when the client computer 200 next interconnects with the license server 100. Resetting a grace enabled license is discussed in greater detail below.

The application 230 determines whether a grace enabled license parameter has been reached in step 640. If a grace enabled license parameter has been reached the application 230 is closed. The grace enabled license parameter can include various items. For example, a parameter may include a number of times the application 230 is operable on a client computer 200 when the client computer 200 is disconnected from the server 100. A parameter may include a total number of hours the application 230 is operable on a client computer 200 when the client computer 200 is disconnected from the server 100. A parameter may include a maximum number of days the application 230 is operable on the client computer 200 when the client computer 200 is disconnected from the server 100.

Grace licensing, according to the present invention, can provide the end user with a temporary solution so the user can continue to work with the application 230 if the client computer 200 becomes disconnected with the license server 100 for intentional or unintentional reasons. When the application 230 obtains a license from the network license server 100 for which grace licensing is enabled, the license may include may include a data string defining multiple records or fields, wherein each record can correspond to an attribute associated with a license policy, a particular application for which the license policy applies, or other information. Each license may include at least one attribute associated with the license policy, a number of allocations for using the particular application 230, and/or at least one other attribute associated with the identity of the particular application 230. The application 230 running on the client computer 200 requests a license from the license server 100 running on the network 300. The license server 100 authorizes the application 230 based on a licensing agreement as defined in associated license code. The application 230 can then run on the client computer 200. When disconnected from the network 300, since the application 230 on the client computer 200 can not be authorized by the license server 100, the application 230 would fail to run.

The grace licensing provides the end user some temporary solutions so that they can continue to work “for a while.” Limitations may be imposed on the grace license including, but not limited to the number of times the protected application may run on the client computer 200 when the client computer 200 is disconnected from the server 100, the total number of hours the application 230 may run on the client computer 200 when the client computer 200 is disconnected from the server 100, the maximum number of days the application 230 may be used on the client computer 200 when the client computer 200 is disconnected from the server 100, etc. When the application 230 obtains a license from the network license server 100 for which grace licensing is enabled, the grace licensing information may be automatically stored on the client computer 200 without any user interaction. Next time, when the application 230 is launched in the absence of the network 300, the grace licensing becomes effective.

For the grace licensing, the user needs to have previously received a grace enabled license during a network license request for a grace enabled license. The grace period may begin when an application first runs in a mode where it cannot get a valid license. For example, assume the grace criteria for application X is defined as maximum days as two and maximum hours twenty. So, if the user last used the application X during the weekdays on Wednesday when connected to the corporate network, and then runs the application X during the weekends on Saturday, such that the user now does not have a valid license on their computer, this is the time when the grace licensing becomes effective and the grace period starts. The user may then be able to use the application X on Saturday and Sunday (days not exceeding two and assuming that total hours do not exceed twenty).

The grace licensing information on the client computer can be reset in a variety of ways. The grace licensing information may be reset on the client computer 200 during a next valid grace enabled license request from the license server 100, or when the client computer 200 next connects to the network server 100. The grace licensing information may be reset automatically on the client computer 200 without connecting to the license server 100. For example, assume a grace criteria for a grace license of seven days and sixteen hours is provided for application Y, and the user makes use of the total hours, that is, sixteen in the first three days. Now, the user has to wait for another four days (lock in period) to avail another grace cycle of the same number of days and hours (e.g, seven and sixteen, respectively).

In summary, a method and/or system for providing grace licensing to disconnected network license users provides a server with a grace enabled license with a grace criteria, provides a client computer with an application operable with the grace enabled, provides the grace enabled license from the server to the client computer when the client computer is communicatively connected to the server, and operates the application on the client computer according to grace criteria when the client computer is disconnected from the server.

The server computer can be a plurality of server computers, and the client computer can be a plurality of client computers, the application can be a plurality of applications, and the grace enabled license can be a plurality of grace enabled licenses. The grace criteria can include at least one parameter. The at least one parameter can include a number of times the application is operable on a client computer when the client computer is disconnected from the server. The at least one parameter can include a total number of hours the application is operable on a client computer when the client computer is disconnected from the server. The at least one parameter can include a maximum number of days the application is operable on a client computer when the client computer is disconnected from the server. The server can include a database with a plurality of grace enabled licenses and at least one non-grace enabled license.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

We claim:

1. A method for providing grace licensing to disconnected network license users, said method comprising:
providing a server with a grace enabled license having a grace criteria;
providing a client computer with an application operable with the grace enabled license;
providing the grace enabled license from the server to the client computer when the client computer is communicatively connected to the client computer; and
operating the application on the client computer according to the grace criteria when the client computer is disconnected from the server.

2. A method according to claim 1, wherein the step of providing a server computer further comprises providing a plurality of server computers.

3. A method according to claim 1, wherein the step of providing a server with a grace enabled license further comprises providing the server computer with a plurality of grace enabled licenses.

4. A method according to claim 1, wherein the step of providing a server further comprises configuring the grace criteria with at least one parameter.

5. A method according to claim 4, wherein the step of configuring the grace criteria further comprises configuring one of the at least one parameter with a reset parameter.

6. A method according to claim 4, wherein the step of configuring the grace criteria further comprises configuring one of the at least one parameter with a number of times the application is operable on a client computer when the client computer is disconnected from the server.

7. A method according to claim 4, wherein the step of configuring the grace criteria further comprises configuring one of the at least one parameter with a total number of hours the application is operable on a client computer when the client computer is disconnected from the server.

8. A method according to claim 4, wherein the step of configuring the grace criteria further comprises configuring one of the at least one parameter with a maximum number of days the application is operable on a client computer when the client computer is disconnected from the server.

9. A method according to claim 1, wherein the step of providing a client computer further comprises providing a plurality of client computers.

10. A method according to claim 1, wherein the step of providing a client computer with an application further comprises providing the client computer with a plurality of applications.

11. A system for providing grace licensing to disconnected network license users, said system comprises:
a server having a grace enabled license with a grace criteria; and
a client computer having an application operable with the grace enabled license, the client computer being communicatively connectable to the server and having received the grace enabled license from the server,
wherein the application is operable on the client computer according to the grace criteria when the client computer is disconnected from the server.

12. A system according to claim 11, wherein said client computer comprises a plurality of client computers.

13. A system according to claim 11, wherein said application comprises a plurality of applications.

14. A system according to claim 11, wherein said grace enabled license comprises a plurality of grace enabled licenses.

15. A system according to claim 11, wherein said grace criteria comprises at least one parameter.

16. A system according to claim 15, wherein said at least one parameter comprises at least one reset parameter.

17. A system according to claim 15, wherein said at least one parameter comprises a number of times the application is operable on a client computer when the client computer is disconnected from the server.

18. A system according to claim 15, wherein said at least one parameter comprises a total number of hours the application is operable on a client computer when the client computer is disconnected from the server.

19. A system according to claim 15, wherein said at least one parameter comprises a maximum number of days the application is operable on a client computer when the client computer is disconnected from the server.

20. A system according to claim 11, wherein said client computer comprises:
a processing unit;
memory; and
a license database comprising a plurality of grace enabled licenses and at least one non-grace enabled license.
